(19) United States
(12) Patent Application Publication
(10) Pub. No.: US 2005/0214500 A1
(43) Pub. Date: Sep. 29, 2005

(54) System and method for reducing sound transmission

(76) Inventor: Robert Malcolm Hallows, Matamata (NL)

Correspondence Address: MERCHANT & GOULD PC, P.O. BOX 2903, MINNEAPOLIS, MN, 55402-0903, US

(21) Appl. No.: 10/496,199

(22) PCT Filed: Nov. 22, 2002
(86) PCT No.: PCT/NZ02/00256

§ 371 Date: Mar. 24, 2005

(30) Foreign Application Priority Data
Nov. 22, 2001 (NZ) 515694

(51) Int. Cl. B32B 3/14; B32B 3/16; B32B 3/26

(52) U.S. Cl. 428/77

(57) ABSTRACT

A sound transmission reduction system for use between a floor or other integer of a building construction and a suitable covering for said floor or other integer includes (I) a rigid single layer substrate of gypsum fibreboard, fibre cement, hardboard, plywood or stabilised reconstituted wood, having a thickness of not more than 14 mm; (II) a single resilient layer having a thickness of not more than 10 mm secured or securable to one surface of said substrate; (III) the resilient layer being secured or securable on its opposite surface to said floor or other integer. The arrangement is such that in use the securing together of the substrate and the resilient layer and the securing of the resilient layer to the floor or other integer provides a reduction of sound transmission through the floor or other integer. A method of reducing sound transmission is also disclosed.

### TECHNICAL FIELD

The present invention relates to sound transmission reduction in building constructions and particularly but not exclusively to sound transmission through concrete floors.

### BACKGROUND ART

For simplicity the present invention will be described in the context of its use with a concrete floor. It is to be understood, however, that the present invention would have application wherever control of sound transmission, particularly structure-borne sound transmission, through a solid floor or even wall of any material was required.

In apartment blocks and other close proximity residential dwellings there is a recognised need for effective sound proofing between rooms and between dwellings. This is of increasing importance, at least in New Zealand and Australia, as occupant expectations and building code requirements increase.

A particular problem is in respect of relatively low frequency, and in the case of hard floor surfaces high frequency, sound transmission through the floors of a building.

A known method of reducing interfloor sound transmission involves the use of a relatively thick resilient layer, often rubber, beneath the floor covering. However, previous systems all suffer from disadvantages relating to their total thickness, acoustic performance and/or suitability for use with all common types of floor coverings. In particular some of the prior art systems are unsuitable for use with relatively rigid and brittle coverings such as ceramic tiles.

Australian patent AU 403,047 describes a laminate comprising a polyvinylaromatic resin bonded to a wood chip board upper layer. Such chip board may provide an unsuitable surface for many floor coverings, including ceramic tiles or vinyl. Even if a further layer is added between the chip board layer and the tiles, the chip board may require a surface treatment and/or a further stabilisation layer to be added, which may increase the cost and the time required for installation.

International publication WO 98/21027 describes a sound absorbing resilient layer comprising a rubber underlay, preferably manufactured from recycled tyres, with a grooved lower surface. The resilient layer is preferably between 11/64″ (˜4.4 mm) and 3″ (˜76 mm), and most preferably between ⅜″ (˜9.5 mm) and 1″ (˜25.4 mm). The grooves in the resilient layer are intended to enhance the sound attenuating properties of the resilient layer by limiting the contact area with the sub-floor.

This system, particularly in its more preferred form, may be relatively thick. This may be undesirable as the total height of each living space incorporating the resilient layer must be increased to ensure that regulations regarding ceiling to floor spacing are complied with. This may increase the cost of buildings such as multi-story apartment blocks. Where a maximum building envelope limit is imposed, thicker overlays can reduce the number of levels for rent. From an occupant and designer perspective, there is often resistance to thicker overlays because a small step results where the thick overlay is installed beneath hard surfaces, but not beneath carpet. This may result in unsatisfactory aesthetics and may compromise safety.

U.S. Pat. No. 5,968,630 describes a laminate which includes a combination of a low density polyethylene foam and low density polyethylene film which is loose laid on a concrete sub-floor. A wooden laminate flooring is installed over the polyethylene layers. The system is intended to help smooth irregularities in the sub-floor and to introduce a measure of resilience to the floor as a whole.

One problem with this system may be that the upper layer may be too flexible to allow rigid floor coverings such as ceramic tiles to be used without a risk of cracking, and may therefore only be suitable for flexible floor coverings such a vinyl or rubber tiles. The flexible floor may lack a solid feel which many people may prefer. The foam may also compress locally under high pressure loading, such as that provided by some furniture, thereby reducing the acoustic performance of the system. Even if the foam is not compressed in this way, the acoustic performance of the system may not be sufficient for some applications.

EP 864,712 describes a simple sound rubber mat which reduces the noise produced by an upper timber floor. This system may suffer from the problems associated with a lack of rigidity common to systems which use a timber upper surface, as described above.

EP 829,588 describes a board suitable for covering a floor or wall which is manufactured from a mixture of rubber scrap and expanded polystyrene.

Other systems of the prior art have involved pouring an upper layer of a settable substance on top of a resilient layer, the upper layer setting to provide a relatively stiff substrate on top of the resilient layer. Systems of this type may be inconvenient to install and in particular may slow the progress of the construction while the upper layer cures.

None of the systems described above combine the characteristics of acceptable noise attenuation, easy installation, ability to cope with sustained in-use serviceability loads, relatively low overall thickness and broad compatibility with most common flooring surfaces.

The Applicant does not concede that any or all of the patents referred to above necessarily form part of the common general knowledge of a skilled addressee, or are necessarily patents which would be discovered by a diligent searcher.

### OBJECTS OF THE INVENTION

It is therefore an object of the present invention to provide a sound transmission reduction system for a building construction which provides a cost effective and relatively thin and user friendly sound transmission control which overcomes or at least ameliorates disadvantages of present proposals or which at least will provide the public with a useful choice.

Further objects of the invention will become apparent from the following description.

### DISCLOSURE OF THE INVENTION

According to one aspect of the present invention there is provided a sound transmission reduction system for use between a floor or other integer of a building construction and a suitable covering for said floor or other integer includes;
a rigid single layer substrate of gypsum fibreboard, fibre cement, hardboard, plywood or stabilised reconstituted wood, having a thickness of not more than 14 mm;
a single resilient layer having a thickness of not more than 10 mm secured or securable to one surface of said substrate;
said resilient layer being secured or securable on its opposite surface to said floor or other integer, the arrangement being such that in use the securing together of said substrate and said resilient layer and the securing of said resilient layer to said floor or other integer provides a reduction of sound transmission through said floor or other integer.

Preferably, said substrate may be between 4 mm and 14 mm thick.

Preferably, said substrate may be between 6 mm thick and 14 mm thick.

Preferably, said substrate may be substantially 6.5 mm thick.

Preferably, said substrate may have a modulus of elasticity of between 3 GPa and 18 GPa.

Preferably, said substrate may have a modulus of elasticity of substantially 7 GPa.

Preferably, said substrate may have a modulus of rupture of between 5 MPa and 25 MPa.

Preferably, said substrate may have a modulus of rupture of substantially 11 MPa.

Preferably, said resilient material may be between 2 mm and 10 mm thick.

Preferably, said resilient material may be between 2 mm and 3 mm thick.

Preferably, said resilient material may be substantially 3 mm thick.

Preferably, said resilient layer may have a density of between 20 kg/m³ and 150 kg/m³.

Preferably, said resilient layer may have a density of substantially 75 kg/m³.

Preferably, said resilient layer may be a polyolefin.

Preferably, said resilient layer may be a foamed polyethylene.

Preferably, said substrate may be gypsum fibreboard.

Preferably, the total thickness of said system may be less than 11 mm.

Preferably, said sound transmission reduction system may have a point load failure test result, as herein defined, of at least 1.5 kN.

Preferably, said sound transmission reduction system may have a point load failure test result, as herein defined, of at least 1.8 kN.

Preferably, said substrate may include a plurality of sheets, with adjacent edges of said sheets glued together to form butt joints.

According to a second aspect of the present invention a method of reducing sound transmission through a floor or other integer of a building construction includes:
securing one side of a single resilient layer having a thickness of not more than 10 mm to said floor or other integer;
securing a single substrate of gypsum fibreboard, fibre cement, hard board plywood or stabilised reconstituted wood, of thickness not more than 14 mm, to an opposite side of said single resilient layer;
wherein the resilient layer is secured to said substrate and said floor or other integer such that sound transmission through said floor or other integer is reduced.

Preferably, the method may include the step of securing a suitable covering to said substrate on an opposite side to said resilient layer.

Preferably, the method may include the step of securing said single resilient layer to said floor or other integer by means of a contact adhesive.

Preferably, the method may include the step of securing said substrate to said single resilient layer by means of a contact adhesive.

Preferably, said resilient material may be a polyolefin.

Preferably, said resilient material may be a foamed polyethylene.

Preferably, said substrate may be formed by a plurality of sheets of gypsum fibreboard, fibre cement or hard board, the method including the step of gluing adjacent edges of said sheets together to form butt joints.

Preferably, said substrate may be gypsum fibreboard.

According to a further aspect of the present invention a sound transmission reduction system and/or a method of reducing sound transmission is substantially as herein described with reference to FIG. 1 or FIG. 2.

Further aspects of this invention which should be considered in all its novel aspects will become apparent from the following description given by way of example and with reference to the accompanying drawings.

### BRIEF DESCRIPTION OF THE DRAWINGS

FIG. 1: shows very diagrammatically a cross-sectional view through one possible embodiment of the invention;

FIG. 2: shows very diagrammatically a cross-sectional view through a joint in the embodiment of FIG. 1;

FIG. 3: shows a graph of the performance of the present invention compared to a bare concrete slab;

FIGS. 4 & 5: show graphs of the performance of the present invention compared with presently available floor coverings across a range of frequency;

FIG. 6: shows a comparison of the present invention with other available floor coverings in respect of its impact insulation class (IIC).

FIG. 7: shows a graph comparing the point load failure of the present invention with other available systems.

### BEST MODE FOR CARRYING OUT THE INVENTION

In controlling sound transmission of noise within and between multi-unit dwellings the impact insulation class (IIC) rating is of particular significance. Many such dwellings will have concrete floors, and the need to reduce impact sound transmitted through such floors is of particular concern. Typical solutions to date have utilised multiple layers of various materials such as gypsum fibre and plywood, typically with the joints within the multi-layer system being staggered in order to provide additional strength. Other solutions have incorporated thick layers of a resilient material such as glass wool or mineral wood mat typically being loose laid over a floor and relying on dead weight for placement. It will be appreciated that typically such present solutions have tended to be at least 30 mm thick, usually more.

Other solutions such as the use of shredded rubber mats or bitumen based mats have proved to be expensive and/or not installer-friendly. In contrast the present invention due to its use of materials is expected to be substantially less costly while also being installer-friendly.

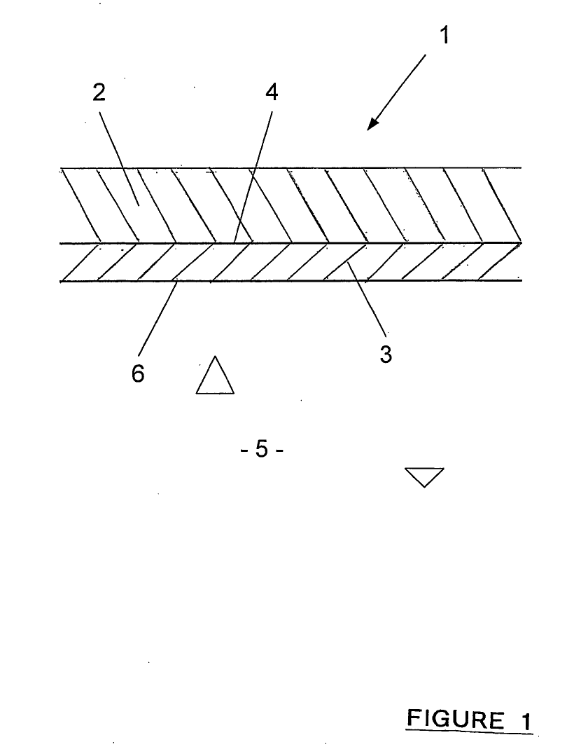

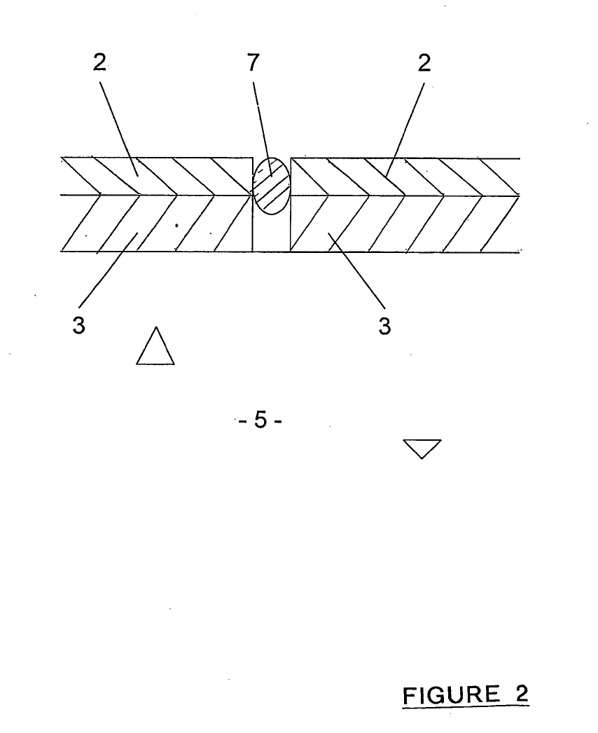

Referring to the accompanying drawings and initially to FIGS. 1 and 2 an embodiment of the present invention is shown very diagrammatically in cross-section and including in FIG. 2 the join between substrate sheets.

In the sound transmission reduction system of the present invention as shown and referenced generally by arrow 1, a single layer sheet material substrate 2 is provided, on which a suitable floor covering (not shown), for example ceramic floor tiles, vinyl, timber or any other suitable floor covering such as are well know to those skilled in the art, may be laid.

The substrate 2 is not more than 14 mm thick, or preferably 4 mm to 14 mm thick and suitably 6.5 mm thick gypsum fibreboard, although other suitably light, strong, rigid and dimensionally stable materials such as fibre cement, hard board, plywood, stabilised reconstituted wood or the like may be used. Some of these substrates 2, for example plywood, may be sufficiently hard wearing to allow the use of paint or polyurethane as a floor covering in areas which are not subject to high traffic.

Preferably the substrate may provide a Modulus of Elasticity of 3 Gpa to 18 Gpa and a Modulus of Rupture of between 5 Mpa to 25 Mpa, and more preferably a Modulus of Elasticity of substantially 7 GPa and a Modulus of Rupture of substantially 11 MPa.

An under surface of the substrate 2 is shown secured with a resilient layer 3. Suitably this securement is by means of a layer of adhesive 4. Such adhesive 4 may be provided across substantially all or merely part of the adjacent surfaces of the substrate 2 and the resilient layer 3 or may be by spot adhesive. The adhesive layer 4 may suitably be a contact adhesive suitably with a less than 24 hour dry time. The suitable adhesive may for example, be Bostik (trademark) 1181 contact adhesive.

Installers of the system may prefer to use gypsum fibreboard as the substrate 2 due to the ease with which its dimensions may be varied on site, suitably by the “score and snap” method, by which a sharp blade is pressed firmly and run across the face of the substrate 2, and resilient layer 3 if already adhered to the substrate 2, to cut the resilient layer 3 and score the substrate 2. The edges of the substrate 2 furthest from either side of the cut are then brought together to snap the substrate 2 into two pieces.

Gypsum fibreboard may also be manufactured in suitable size sheets, typically in the order of 1800 mm×1200 mm, which an installer may find particularly convenient as they are of such a size, shape and weight that they may be carried by a single person.

Gypsum fibreboard may also provide a suitable mounting surface for most common floor coverings, and in particular for rigid floor coverings such as ceramic tiles. Installation of the floor covering over gypsum fibreboard may be assisted by the fact that, due to the stiffness of the system, relatively shallow contours in the floor may be smoothed over rather than the substrate 2 following the contour of the floor as may occur in some systems of the prior art. This may improve the appearance of the floor covering. In addition the gypsum fibreboard may provide a pre-sealed surface onto which a suitable floor covering such as tiles may be affixed without further preparation of the surface.

Those skilled in the art will appreciate that some of the advantages mentioned above may also be provided by one of the alternative substrates 2 listed above.

The resilient layer 3 is relatively thin, not more than 10 mm thick, and preferably towards the lower end of that range, suitably of the order of 3 mm thick. Suitably the resilient layer 3 may be a polyolefin with high resilience and with sufficiently low creep and with suitably high compressive strength. Preferably the characteristics of the resilient material 3 would incorporate:
Approximately less than 10% creep at 23° C. in three years under a 5 kPa load.
Approximate water absorption ASTMC-272-53 less than 0.5% by volume absorption after total immersion in water for 24 hours.
Density of 20 to 150 kg/m³.
Thickness of between 2 to 10 mm.
Compressive strength greater than 2 kPa, or more preferably compressive strength at 50% compression of 1.5 kPa.

A suitable material may be a 3 mm layer of foamed polyethylene.

The resilient layer 3 is shown secured to a floor 5, in this example illustrated as a concrete floor.

The securement of the resilient layer 3 to the floor 5 is by means of a further adhesive layer 6. Suitably the adhesive layer 6 utilises a water based trowellable adhesive with a short dry time, preferably less than 1 hour. Almost any suitable adhesive layer 6 may be used, such as urethane for example. The Applicant has found that the choice of adhesive 6 does not impact on the acoustic performance of the invention provided the adhesive layer 6 is reasonably thin.

An important part of the present invention is the combination of a relatively thin resilient layer 3 with a suitably thin substrate 2. If the resilient layer selected is too thick and/or of insufficient density and/or of insufficient compressive strength, then the resilient layer 3 may not provide sufficient support to the substrate 2 to accommodate in service loads. Additionally, an improper resilient layer 3 may result in the substrate 2 flexing sufficiently that cracking of floor coverings such as tiles, or telegraphing of imperfections to a vinyl surface, may occur. Deformation of the resilient layer 3 under localised loads may also significantly reduce the acoustic performance of the system.

Surprisingly however, the Applicant has found that a combination of a suitably dense, suitably thin resilient layer 3 with a suitable substrate 2 not only provides good serviceability, including sufficient strength, rigidity, dimensional stability and flatness, but also excellent impact sound insulation characteristics.

Referring briefly to FIG. 2, where sheets of the substrate 2 need to be joined a high strength multi-purpose construction adhesive joint, suitably with less than 24 hour dry time and with water resistance, is provided along the adjoining edges of the sheet 2 to create a butt type joint. The joint 7 between the sheets 2 ensures that vertical loads are transferred across the substrate 2 and is also effective at helping to prevent the telegraphing of cracks across the substrate 2. The ability of the system to perform adequately with the joints 7 glued in this way avoids the need to use double layers of substrate 2 with overlapping joints, such as are common in the systems of the prior art. This may contribute to the ease and speed of installation of the system as well as keeping the overall thickness of the system to a minimum.

In view of the thickness of presently available solutions to the impact sound transmission problem, and in particular the thickness of some of the resilient layers of the prior art, and the choice of materials used, it would be expected that the present invention as shown in FIGS. 1 and 2 would not provide adequate impact sound transmission control, or at least would not perform as well as currently available systems.

It has been unexpectedly found in tests carried out on the present invention that it in fact performs better than most currently available and more expensive systems of similar thickness and may perform better than many thicker systems of the prior art, while in many cases offering a simpler construction.

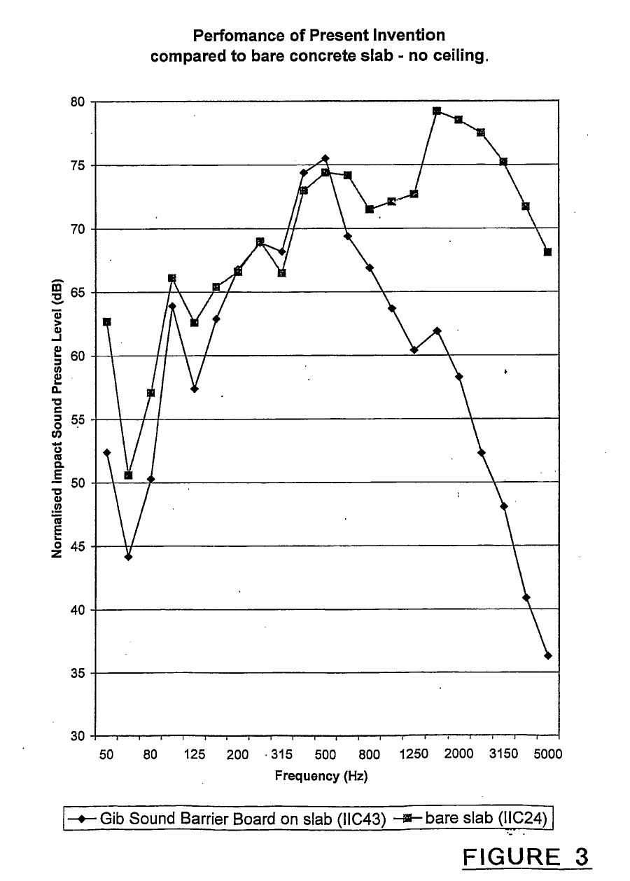

Referring therefore to FIG. 3 the graph shows the performance of the present invention, referred to herein as the GIB® sound barrier board concrete system or abbreviated as GSBC, as compared to a bare concrete slab with no ceiling.

The sample tested used a 3 mm resilient polyethylene layer adhered to a concrete surface by a layer of adhesive. The layer of adhesive, around 0.5 mm-1 mm thick, was applied by a 3 mm deep notched trowel. The resilient layer was pressed onto the adhesive. A sheet of 6.5 mm gypsum fibreboard was adhered to the upper surface of the polyethylene layer via a layer of adhesive of less than about 0.2 mm, thereby providing a sound transmission reduction system of around 10.5 mm total thickness.

300 mm×300 mm ceramic tiles were adhered to the substrate with latex modified cementitious adhesive. The tiles were spaced 3 mm apart, with the gaps grouted.

It would seem that substantial impact sound control is provided at all frequencies with the exception of the region around 500 Hz, where resonance of the system appears to occur. Those skilled in the art will appreciate that all overlay systems may suffer from such a resonance effect at some frequencies.

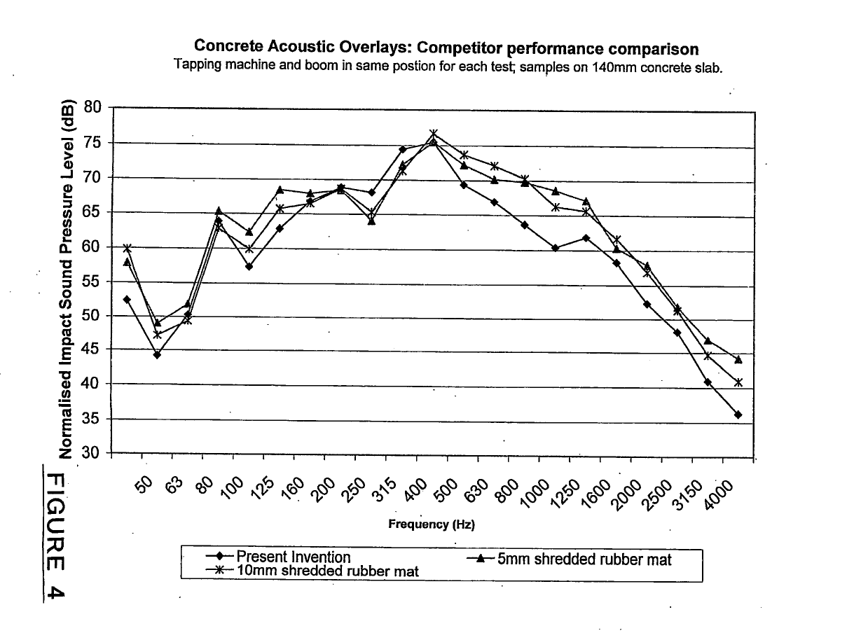

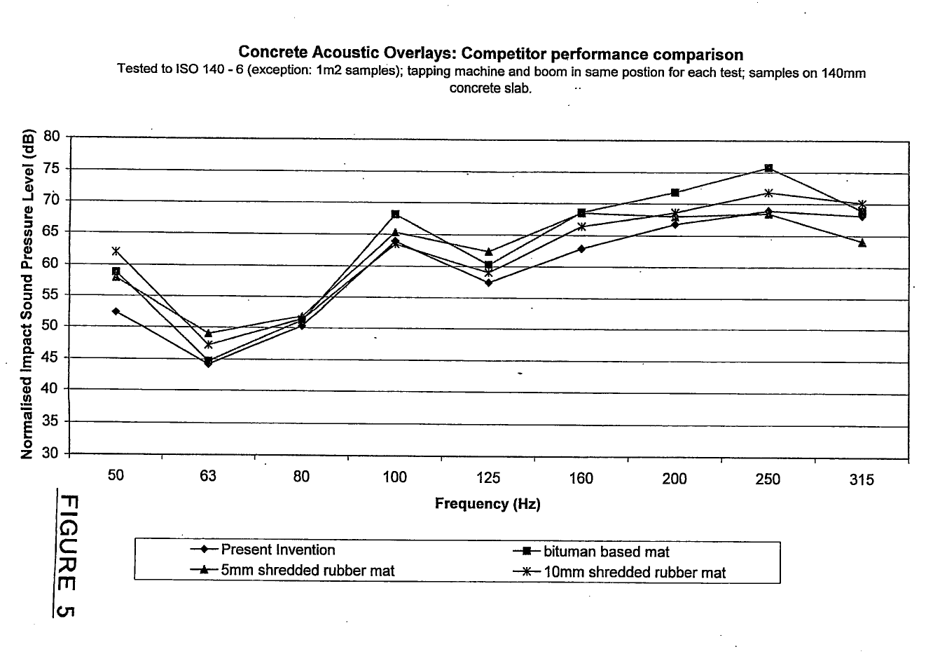

Turning then to FIGS. 4 and 5, the test sample of the present invention described above is compared with presently available systems utilising a bitumen-based mat and 5 mm and 10 mm shredded rubber mats. It would appear that the present invention performs well across the range of frequencies and better than the alternatives for some of the frequencies.

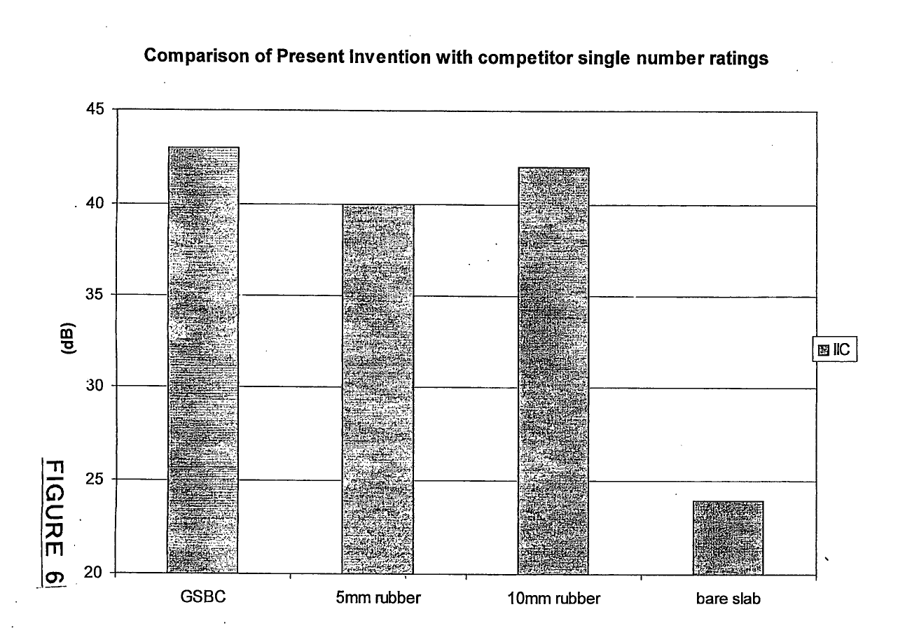

Then in FIG. 6 the present invention (GSBC) is compared with the rubber mat alternative systems as far as its IIC rating is concerned and it is seen to be higher than either of the alternatives.

Acoustic testing of one sample which had a 3 mm resilient layer 3 with a density of 75 kg/m³, a 6.5 mm gypsum fibreboard substrate 2, and covered by a monocottura tiles provided a ΔLnw of 18 dB (or ΔIIC of 20 dB when tested to ISO 140-8:1997.

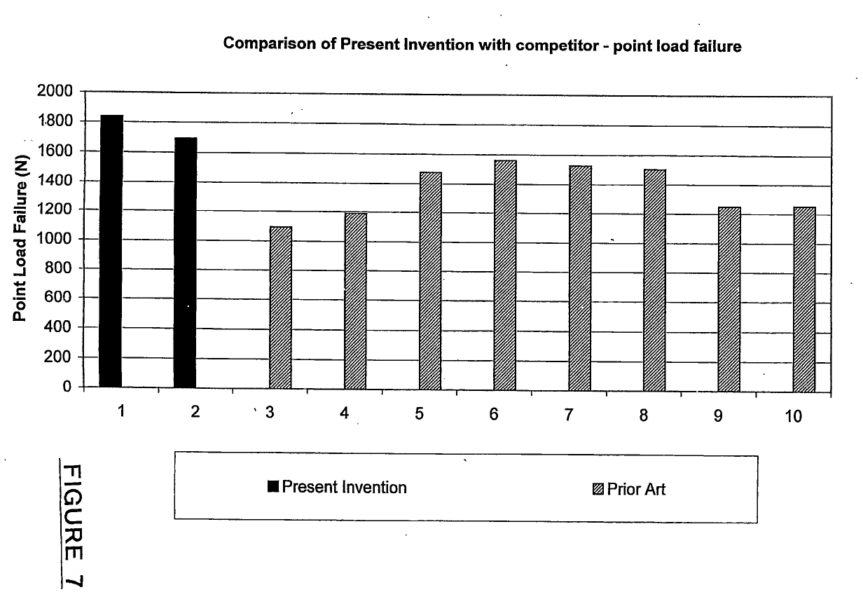

FIG. 7 shows point load failure results for the present invention and a number of systems of the prior art, each with two different tiles on their upper surface. All references herein to point load failure test results are with respect to tests carried out as described below with monocottura tiles having a Modulus of Rupture of 40 MPa.

The embodiment of the present invention tested used a 3 mm resilient layer and 6.5 mm substrate. The examples of the prior art included an 11 mm thick bitumen mat, 5 mm thick shredded rubber mat, 5.5 mm thick shredded rubber mat and 5.1 mm thick bed of trowel-on acoustic adhesive.

The test samples were prepared as follows.

Two 300 mm×300 mm pieces of acoustic overlay were adhered to a concrete substrate using an adhesive specified by the manufacturer of the overlay. The pieces of overlay were butt-jointed as per the manufacturers recommendations, with the exception of the acoustic adhesive which has no join.

One monocottura 300×300×8 mm tile and one 300×300×8 mm porcelain tile were adhered to each overlay using a premium latex modified cementitious tile adhesive. The adhesive was applied along the length of the samples using a 8 mm×8 mm notched trowel angled at 45° to the surface. The tiles were set with a 3 mm gap. The gap was filled with flexible sealant. The tile gap and acoustic overlay joins were aligned on each sample except the bitumen mat, where the tiles were laid to the manufacturers specifications of offsetting the overlay 450 to the tiled surface.

The monocottura tiles had nominal 2.2% water absorption and Modulus of Rupture of 40 MPa. The porcelain tiles had less than 0.2% water absorption and Modulus of Rupture of 54 MPA.

The specimens were allowed to cure for 11 days prior to testing.

The samples were loose laid on the base of an Instron (Trade Mark) universal testing machine. A 25 mm diameter steel ball bearing was pressed onto the surface of the tiles at two points, at a distance of approximately 4 mm from the sealant and 100 mm from the outer edges of each tile.

The load cell was advanced towards the tiles at a rate of 4 mm/minute. Failure was registered as the load at which the tiling system was heard to crack, although a physical crack in the tile was not necessarily visible.

As FIG. 7 shows, the present invention provided a superior point load failure strength of all the samples tested. The point load failure test described above provides results which are representative of in-use serviceability, a higher test result indicating a better in-use serviceability.

A preferred embodiment of the present invention may provide a point load failure test result of at least 1.5 kN, or more preferably at least 1.8 kN, under the test conditions described above.

It is thus seen that a single relatively thin substrate of gypsum fibreboard or the like, and a relatively thin layer of a resilient material such as foam polyethylene secured together and with the resilient layer secured to the floor of a building, can surprisingly provide excellent impact sound transmission solution and provide an in-use serviceability load when covered with a typical floor covering such as ceramic tiles. In that regard it would not be expected that a single thin substrate on a resilient material would sustain in-use serviceability loads when covered with ceramic tiles, due to not being strong enough. However, testing of the present invention has shown it to perform well in that regard.

It is considered that the rigid substrate 2 is providing an effective load spreading across the surface of the resilient layer 3. In this way the superior point load strength is being achieved. In a practical situation this would mean that a heavy item of furniture such as a table would not over time damage the resilient layer 3, in turn damaging its sound control characteristics, as could otherwise happen in previous systems.

Where in the foregoing description, reference has been made to specific components or integers having known equivalents, then such equivalents are incorporated herein as if individually set forth.

Although the above description has been given by way of example with reference to possible embodiments of the invention, it is to be understood that modifications or improvements may be made without departing from the scope of the appended claims.

1. A sound transmission reduction system suitable for use between a floor or other integer of a building construction and a suitable covering for said floor or other integer including:
a rigid single layer substrate of gypsum fibreboard, fibre cement, hardboard, plywood or stabilised reconstituted wood, having a thickness of not more than 14 mm and a modulus of elasticity of between 3 GPa and 18 GPa;
a single resilient layer having a thickness of not more than 10 mm secured or securable to one surface of said substrate;
said resilient layer being secured or securable on its opposite surface to said floor or other integer, the arrangement being such that in use the securing together of said substrate and said resilient layer and the securing of said resilient layer to said floor or other integer provides a reduction of sound transmission through said floor or other integer.

2. The sound transmission reduction system of claim 1 wherein said substrate is between 4 mm and 14 mm thick.

3. The sound transmission reduction system of claim 2 wherein said substrate is between 6 mm thick and 14 mm thick.

4. The sound transmission reduction system of claim 3 wherein said substrate is substantially 6.5 mm thick.

5. (canceled)

6. The sound transmission reduction system of claim 1 wherein said substrate has a modulus of elasticity of substantially 7 GPa.

7. The sound transmission reduction system of claim 1 wherein said substrate has a modulus of rupture of between 5 MPa and 25 MPa.

8. The sound transmission reduction system of claim 7 wherein said substrate has a modulus of rupture of substantially 11 MPa.

9. The sound transmission reduction system of claim 1 wherein said resilient material is between 2 mm and 10 mm thick.

10. The sound transmission reduction system of claim 9 wherein said resilient material is between 2 mm and 3 mm thick.

11. The sound transmission reduction system of claim 10 said resilient material is substantially 3 mm thick.

12. The sound transmission reduction system of claim 1 wherein the resilient layer has a density of between 20 kg/m³ and 150 kg/m³.

13. The sound transmission reduction system of claim 12 wherein said resilient layer has a density of substantially 75 kg/m³.

14. The sound transmission reduction system of claim 1 wherein said resilient layer is a polyolefin.

15. The sound transmission reduction system of claim 14 wherein said resilient layer is foamed polyethylene.

16. The sound transmission reduction system of claim 1 wherein said substrate is gypsum fibreboard.

17. The sound transmission reduction system of claim 1 wherein the total thickness of said system is less than 11 mm.

18. The sound transmission reduction system of claim 1 with a point load failure test result, as herein defined, of at least 1.5 kN.

19. The sound transmission reduction system of claim 18 with a point load failure test result, as herein defined, of at least 1.8 kN.

20. The sound transmission reduction system of claim 1 wherein said substrate includes a plurality of sheets, with adjacent edges of said sheets glued together to form butt joints.

21. A method of reducing sound transmission through a floor or other integer of a building construction including:
securing one side of a single resilient layer having a thickness of not more than 10 mm to said floor or other integer;
securing a single substrate of gypsum fibreboard, fibre cement, hard board plywood or stabilised reconstituted wood, of thickness not more than 14 mm, and having a modulus of elasticity of between 3 GPa and 18 GPa, to an opposite side of said single resilient layer;
wherein the resilient layer is secured to said substrate and said floor or other integer such that sound transmission through said floor or other integer is reduced.

22. The method of claim 21 including the step of securing a suitable covering to said substrate on an opposite side to said resilient layer.

23. The method of claim 21 including the step of securing said single resilient layer to said floor or other integer by means of a contact adhesive.

24. The method of claim 21 including the step of securing said substrate to said single resilient layer by means of a contact adhesive.

25. The method of claim 21 wherein said resilient material is a polyolefin.

26. The method of claim 25 wherein said resilient material is a foamed polyethylene.

27. The method of claim 21 wherein said substrate is formed by a plurality of sheets of gypsum fibreboard, fibre cement or hard board, the method including the step of gluing adjacent edges of said sheets together to form butt joints.

28. The method of claim 21 wherein said substrate is gypsum fibreboard.

29. (canceled)

30. A sound transmission reduction system suitable for use between a floor or other integer of a building construction and a suitable covering for said floor or other integer including:
a rigid single layer substrate of gypsum fibreboard, fibre cement, hardboard, plywood or stabilised reconstituted wood, having a modulus of elasticity of between 3 GPa and 18 GPa;
a single resilient layer secured or securable to one surface of said substrate, the total thickness of said substrate layer and said resilient layer being less than 11 mm;
said resilient layer being secured or securable on its opposite surface to said floor or other integer, the arrangement being such that in use the securing together of said substrate and said resilient layer and the securing of said resilient layer to said floor or other integer provides a reduction of sound transmission through said floor or other integer, and wherein the system has a point load failure test result, as herein defined, of at least 1.5 kN.
